(19) United States
(12) Patent Application Publication
(10) Pub. No.: US 2025/0021610 A1
(43) Pub. Date: Jan. 16, 2025

(54) HUMAN-MACHINE INTERACTION METHOD AND APPARATUS, ELECTRONIC DEVICE AND STORAGE MEDIUM

(71) Applicant: BEIJING BAIDU NETCOM SCIENCE TECHNOLOGY CO., LTD., Beijing (CN)

(72) Inventors: Zeyang LEI, Beijing (CN); Siqi BAO, Beijing (CN); Hua WU, Beijing (CN); Haifeng WANG, Beijing (CN)

(73) Assignee: BEIJING BAIDU NETCOM SCIENCE TECHNOLOGY CO., LTD., Beijing (CN)

(21) Appl. No.: 18/901,831

(22) Filed: Sep. 30, 2024

(30) Foreign Application Priority Data
Dec. 20, 2023 (CN) 202311760276.5

(51) Int. Cl. G06F 16/9535

(52) U.S. Cl. CPC G06F 16/9535

(57) ABSTRACT

A human-machine interaction solution which relates to the field of artificial intelligence technologies, such as natural language processing technologies, large language models, deep learning technologies, or the like, is proposed. The solution may include: acquiring a question input by a user during a conversation with a large language model; retrieving memory information in a memory bank, the memory information being historical memory information about the user; and in response to retrieved memory information required for generating answer information corresponding to the question, taking the retrieved memory information as matched memory information, and generating the answer information by the large language model in conjunction with the matched memory information.

### CROSS-REFERENCE TO RELATED APPLICATION

The present disclosure claims the priority and benefit of Chinese Patent Application No. 202311760276.5, filed on Dec. 20, 2023, entitled “HUMAN-MACHINE INTERACTION METHOD AND APPARATUS, ELECTRONIC DEVICE AND STORAGE MEDIUM”. The disclosure of the above application is incorporated herein by reference in its entirety.

### TECHNICAL FIELD

The present disclosure relates to the field of artificial intelligence technologies, and particularly to a human-machine interaction method and apparatus, an electronic device and a storage medium in the fields of natural language processing technologies, large language models, deep learning technologies, or the like.

### BACKGROUND

Currently, large language models (LLM) demonstrate an excellent capability of processing and generating text, and can understand complex language structures and generate smooth and coherent text.

### SUMMARY

The present disclosure provides a human-machine interaction method, an electronic device and a storage medium.

A human-machine interaction method includes:
acquiring a question input by a user during a conversation with a large language model;
retrieving memory information in a memory bank, the memory information being historical memory information about the user; and
in response to retrieved memory information required for generating answer information corresponding to the question, taking the retrieved memory information as matched memory information, and generating the answer information by the large language model in conjunction with the matched memory information.

An electronic device includes:
at least one processor; and
a memory connected with the at least one processor communicatively;
wherein the memory stores instructions executable by the at least one processor to enable the at least one processor to perform the method as mentioned above.

There is provided a non-transitory computer readable storage medium with computer instructions stored thereon, wherein the computer instructions are used for causing a computer to perform the method as mentioned above.

It should be understood that the statements in this section are not intended to identify key or critical features of the embodiments of the present disclosure, nor limit the scope of the present disclosure. Other features of the present disclosure will become apparent from the following description.

### BRIEF DESCRIPTION OF THE DRAWINGS

The drawings are used for better understanding the present solution and do not constitute a limitation of the present disclosure. In the drawings,

FIG. 1 is a flow chart of a human-machine interaction method according to an embodiment of the present disclosure;

FIG. 2 is a schematic diagram of a relationship between a user, a memory bank, and a large language model in the present disclosure;

FIG. 3 is a schematic structural diagram of a human-machine interaction apparatus 300 according to an embodiment of the present disclosure; and

FIG. 4 shows a schematic block diagram of an electronic device 400 which may be configured to implement the embodiment of the present disclosure.

### DETAILED DESCRIPTION OF EMBODIMENTS

The following part will illustrate exemplary embodiments of the present disclosure with reference to the drawings, including various details of the embodiments of the present disclosure for a better understanding. The embodiments should be regarded only as exemplary ones. Therefore, those skilled in the art should appreciate that various changes or modifications can be made with respect to the embodiments described herein without departing from the scope and spirit of the present disclosure. Similarly, for clarity and conciseness, the descriptions of the known functions and structures are omitted in the descriptions below.

In addition, it should be understood that the term “and/or” only describes an association relationship between associated objects, and indicates that three relationships may exist. For example, A and/or B may indicate three cases: only A exists; both A and B exist; and only B exists. In addition, in this specification, the symbol “/” generally indicates that associated objects have a relationship of “or”.

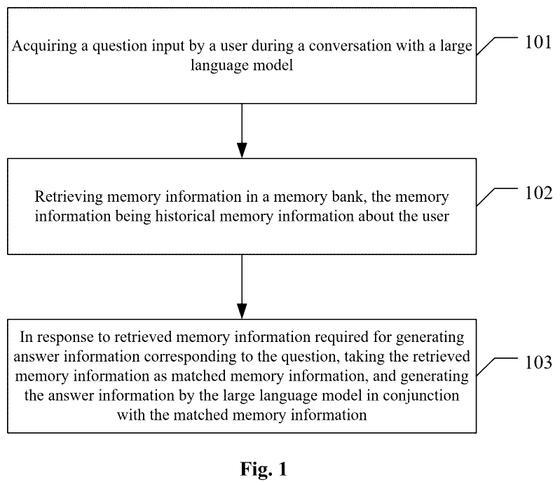

FIG. 1 is a flow chart of a human-machine interaction method according to an embodiment of the present disclosure. As shown in FIG. 1, the method includes the following implementation steps:
step 101: acquiring a question input by a user during a conversation with a large language model;
step 102: retrieving memory information in a memory bank, the memory information being historical memory information about the user; and
step 103: in response to retrieved memory information required for generating answer information corresponding to the question, taking the retrieved memory information as matched memory information, and generating the answer information by the large language model in conjunction with the matched memory information.

The current large language model still has a certain gap from real artificial general intelligence (AGI), and one of important reasons is that the current large language model cannot have a memory capability like a human, thereby limiting a capability of interaction between the large language model and the user.

By adopting the solution of the above method embodiment, the answer information corresponding to the question input by the user can be generated by the large language model in conjunction with the retrieved memory information; that is, the large language model has the memory capability, such that the large language model is more efficient and anthropomorphic when interacting with the user, thereby improving a conversation effect, or the like.

The question input by the user refers to a question input into the large language model when the user conducts a conversation with the large language model, and the large language model can be a chatting robot or an artificial intelligence (AI) assistant, or the like.

For the question input by the user, the memory information in the memory bank can be retrieved. For example, the memory bank may include one or both of a long-term memory bank and a short-term memory bank; the long-term memory bank may include a user memory bank; the user memory bank may include the following memory information: user portrait attribute information of the user; the short-term memory bank may include a conversation memory bank; the conversation memory bank can include the following memory information: historical conversation information between the user and the large language model within recent predetermined duration.

For example, the user portrait attribute information may include user portrait attribute information generated according to one or both of historical conversation information between the user and the large language model and user information of the user collected from a predetermined data source, and the user memory bank can also include memory information about identity setting and/or a personalized requirement of the user stored actively by the user.

That is, the user portrait attribute information may be generated from the historical conversation information between the user and the large language model and/or the user information collected from the predetermined data source. The specific predetermined data source is not limited, and may refer to, for example, a related product, or the like, and the user may perform registration when using the product, and some user information filled in during the registration may be used to generate the user portrait attribute information, or some log information generated when the user uses the product may be used as the user information used to generate the user portrait attribute information. The specific user portrait attribute information is also not limited, and may include, for example, the name, sex, age, education background, work, hobby (preference), or the like, of the user, and the hobby may refer to enjoying travel, delicious food, or the like.

In addition, the user can also actively store some memory information into the user memory bank, such as memory information about the identity setting and/or the personalized requirement of the user. For example, the memory information may be “I am a programmer and please use the ** format when writing codes later”.

The conversation memory bank mainly stores the historical conversation information between the user and the large language model within the recent predetermined duration, i.e., the historical conversation information of the question and the corresponding answer information. A specific value of the predetermined duration can be determined according to actual needs, such as the last month.

For example, the long-term memory bank may further include a system memory bank; the system memory bank can include one or any combination of the following memory information: identity setting information of the large language model, background knowledge information of the large language model and reference document information of the large language model.

The identity setting information refers to related information about an identity of the large language model, such as “you are an AI assistant developed by ** company”; a background knowledge base refers to capabilities of the large language model, and reference documents refer to documents/knowledge, or the like, to which reference can be made when the large language model performs operations, such as questioning, answering, or the like.

In a traditional mode, the large language model cannot effectively span a long-term memory range and quote previous interaction information, thereby limiting application of the large language model in continuous conversations or scenarios in which long-term memory is required; personalized experience cannot be provided due to lack of memory of user historical preferences and interactions; that is, a personalized limitation exists, and in addition, the large language model cannot keep consistency of topics and contexts in continuous interactions due to lack of long-term memory, and the user experience is influenced. By adopting the processing mode of the present disclosure, the memory information in the user memory bank, the system memory bank and the conversation memory bank can be retrieved respectively, such that the large language model can have various memory capabilities, i.e., the long-term user memory capability, the system memory capability, the short-term conversation memory capability, or the like, the problems of the limitation of the application scenarios, the personalized limitation and the consistency of the large language model in the traditional mode are effectively solved, and the large language model is closer to reality on the way to AGI.

For example, the memory information in the system memory bank may be stored in an unstructured form, and/or the user portrait attribute information in the user memory bank may be stored in a key-value pair form, and/or the memory information in the conversation memory bank and the memory information actively stored by the user in the user memory bank may be stored in a vector form.

When the memory information in the system memory bank is stored in the unstructured form, necessary context information, knowledge background, or the like, can be provided for the large language model, which facilitates optimization of response quality and decision logic of the large language model. The user portrait attribute information can be stored in the structured key-value pair form; for example, the key is “sex”, the value is “male”, and the structured storage mode is favorable for quickly and accurately retrieving the memory information; that is, an efficiency, accuracy, or the like, of retrieval of the memory information can be improved. The memory information in the conversation memory bank and the memory information actively stored by the user in the user memory bank can be encoded into a vector form for storage, an encoding way is not limited, and the adoption of the vectorized memory information representation facilitates efficient retrieval and comparison of the memory information, or the like. In a word, the solution of the present disclosure has high flexibility and diversity in storage of the memory information, and can support storage and processing of various forms of memory information, so as to meet use requirements of different scenarios, or the like.

For example, in response to acquiring an operation instruction issued by the user for any memory bank, a corresponding memory bank operation may be completed according to the operation instruction, the memory bank operation including addition of new memory information, deletion of existing memory information and modification of the existing memory information.

Dynamic management (mainly referring to addition, deletion and modification management) of the memory information in the memory bank can be realized, and for any memory bank, the new memory information can be added, the existing memory information can be deleted or the existing memory information can be modified; besides manual realization of the dynamic management, in practical application, the dynamic management can be automatically realized; for example, the memory information unused in predetermined duration can be deleted, and through the dynamic management, accuracy, reliability, or the like, of the memory information in the memory bank can be improved.

In addition, for example, the conversation information generated between the user and the large language model may be stored in the conversation memory bank in real time, and in response to determining that the stored conversation information meets an extraction condition, key information may be extracted from the stored conversation information, and the stored conversation information be replaced with the extracted key information.

For example, the question and answer information generated each time in the conversation process between the user and the large language model can be stored in the conversation memory bank in real time, and when the information of 3 round conversations is stored, the extraction condition may be considered to be met, the key information can be extracted from the information of the 3 round conversations, the information of the 3 round conversations can be replaced by the extracted key information, and then, after the information of next 3 round conversations is stored, the processing can be repeated.

Therefore, optimization and integration of the conversation information can be realized, and a relatively small amount of useful information is extracted from a large amount of data to be stored, thus saving a storage resource, and improving a retrieval speed, a retrieval accuracy, or the like.

In addition, for example, in response to determining that a memory conversion condition is met and determining that the user portrait attribute information in the user memory bank is required to be updated according to the memory information in the conversation memory bank, the user portrait attribute information may be updated according to the memory information in the conversation memory bank.

For example, the memory conversion condition may be determined to be met at twelve o'clock every night, whether the user portrait attribute information in the user memory bank is required to be updated may be determined according to the memory information in the conversation memory bank, and if yes, the user portrait attribute information is updated correspondingly; for example, the user hobby is modified or supplemented.

By the above processing, short-term conversation memory may be converted into long-term memory, which means that not only the short-term conversation memory of the user and the large language model can be memorized, but also the short-term conversation memory can be filed as the long-term memory for use in a future interaction, such that the user portrait attribute information of the user can be continuously learned and updated, and thus is more comprehensive and accurate.

As described above, in response to the retrieved memory information required for generating the answer information corresponding to the question, the retrieved memory information may be taken as the matched memory information, and the answer information may be generated by the large language model in conjunction with the matched memory information.

A way of determining the required memory information is not limited. For example, the required memory information may be determined according to the question input by the user and the historical conversation information of the current conversation. For example, specifically, for different memory banks, a corresponding neural network model may be obtained through pre-training, and correspondingly, the matched memory information may be determined by the neural network model from the corresponding memory bank according to the question input by the user, the historical conversation information of the current conversation, or the like.

For example, in response to acquiring the matched memory information from only one memory bank, the matched memory information may be converted into a predetermined format to obtain a first conversion result, the answer information may be generated using the large language model in conjunction with the first conversion result, and in response to acquiring the matched memory information from at least two different memory banks, the matched memory information acquired from the different memory banks may be fused, the fusion result may be converted into the predetermined format to obtain a second conversion result, and then, the answer information may be generated using the large language model in conjunction with the second conversion result.

For example, assuming that the matched memory information is acquired from the user memory bank and the conversation memory bank, the matched memory information can be fused, a fusion way is not limited, and the memory information input into the large language model can be simplified through fusion, thereby improving a processing efficiency, or the like, of the large language model; in addition, format conversion can be further carried out on the obtained fusion result, the converted format is also not limited, such as a format which can be more easily identified and understood by the large language model, the conversion result can be further used as additional input of the large language model for the large language model to generate the answer information, and if the matched memory information is obtained from only one memory bank, the format conversion can be directly carried out on the matched memory information, and then, the conversion result can be used as additional input of the large language model. In short, by performing the processing, such as fusion, format conversion, or the like, the processing efficiency of the large language model, the accuracy of the processing result, or the like, can be improved.

In particular, if no matched memory information is obtained, the answer information may be generated in a conventional manner using the large language model.

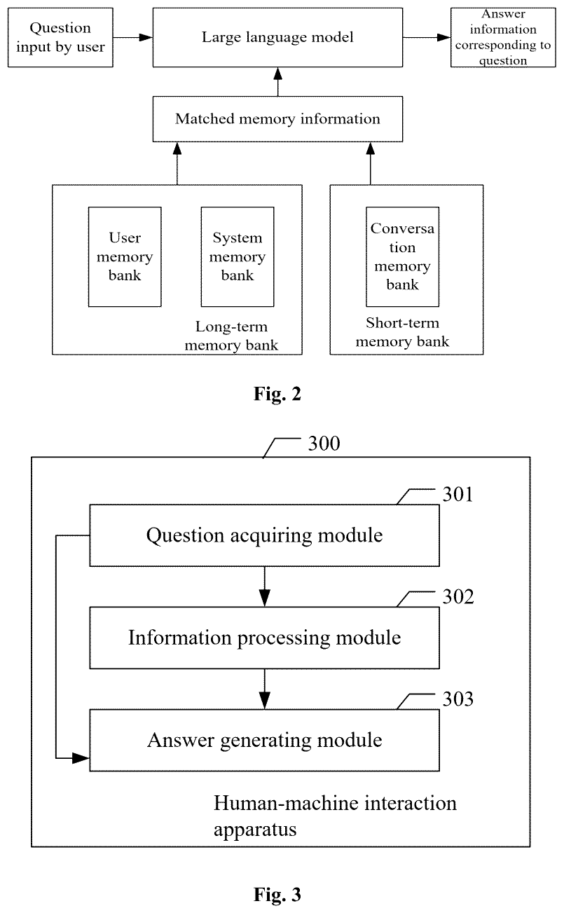

In conjunction with the above description, FIG. 2 is a schematic diagram of a relationship between the user, the memory bank, and the large language model in the present disclosure. As shown in FIG. 2, the memory bank includes the long-term memory bank and the short-term memory bank, the long-term memory bank includes the user memory bank and the system memory bank, the short-term memory bank includes the conversation memory bank, and for the question input by the user, the matched memory information can be obtained by retrieving the memory information in the memory bank, and then, the answer information corresponding to the question can be generated by using the large language model in conjunction with the matched memory information. It can be seen that the large language model in the solution of the present disclosure is a large language model with a memory enhancement function.

The solution of the present disclosure can be further exemplified as follows:
User: I am Xiaoming, what's your name?
Large language model: I am an AI assistant developed by ** company, can I help you?
User: I will travel to place A (a country) next week, is there any suggestion?
Large language model: Certainly, which kind of travel suggestions are you interested in? Delicious food?
User: Yes, I'm interested in delicious food.
Large language model: In place A, you must not miss traditional pizzas and spaghetti; for example, in place B (a city in place A), *** restaurant is very famous, and in place C (another city in place A), I recommend *** restaurant to you, the spaghetti of which has a unique taste.
User: It sounds great, I must go to try it.

### (One Month Later)

User: Hello.
Large language model: Hello, Xiaoming, did you travel to place A?
User: Yes, I ate the recommended delicious food, it is very delicious, thanks.
Large language model: My pleasure, if you want to know more delicious food later, you can always call me.
. . .

In the above example, the large language model may introduce itself as “an AI assistant developed by *** company” according to the memory information in the system memory bank, may learn from the user portrait attribute information in the user memory bank that Xiaoming likes delicious food, and correspondingly may ask whether Xiaoming is interested in the delicious food, may further refer to the previous conversation information in the subsequent conversation, that is, may trace back the historical conversation information between Xiaoming and the large language model, and may ask Xiaoming “did you travel to place A?” when knowing from the memory information in the conversation memory bank that Xiaoming wanted to travel to place A before, thereby providing more personalized and coherent interactive experience for the user Xiaoming.

It should be noted that for simplicity of description, the above-mentioned embodiment of the method is described as combinations of a series of acts, but those skilled in the art should understand that the present disclosure is not limited by the described order of acts, as some steps may be performed in other orders or simultaneously according to the present disclosure. Further, those skilled in the art should also understand that the embodiments described in this specification are preferred embodiments and that acts and modules referred to are not necessary for the present disclosure.

The above is a description of an embodiment of the method, and an embodiment of an apparatus according to the present disclosure will be further described below.

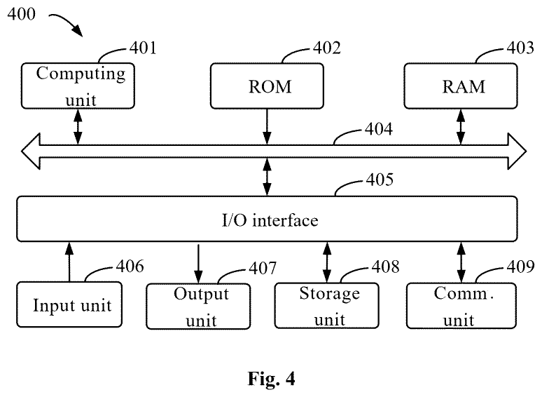

FIG. 3 is a schematic structural diagram of a human-machine interaction apparatus 300 according to an embodiment of the present disclosure. As shown in FIG. 3, the apparatus includes:
a question acquiring module 301 configured to acquire a question input by a user during a conversation with a large language model;
an information processing module 302 configured to retrieve memory information in a memory bank, the memory information being historical memory information about the user; and
an answer generating module 303 configured to, in response to retrieved memory information required for generating answer information corresponding to the question, take the retrieved memory information as matched memory information, and generate the answer information by the large language model in conjunction with the matched memory information.

By adopting the solution of the above apparatus embodiment, the answer information corresponding to the question input by the user can be generated by the large language model in conjunction with the retrieved memory information; that is, the large language model has the memory capability, such that the large language model is more efficient and anthropomorphic when interacting with the user, thereby improving a conversation effect, or the like.

For the question input by the user, the information processing module 302 can retrieve the memory information in the memory bank.

For example, the memory bank may include one or both of a long-term memory bank and a short-term memory bank; the long-term memory bank may include a user memory bank; the user memory bank can include the following memory information: user portrait attribute information of the user; the short-term memory bank may include a conversation memory bank; the conversation memory bank can include the following memory information: historical conversation information between the user and the large language model within recent predetermined duration.

For example, the user portrait attribute information may include user portrait attribute information generated according to one or both of historical conversation information between the user and the large language model and user information of the user collected from a predetermined data source, and the user memory bank can also include memory information about identity setting and/or a personalized requirement of the user stored actively by the user.

For example, the long-term memory bank may further include a system memory bank; the system memory bank can include one or any combination of the following memory information: identity setting information of the large language model, background knowledge information of the large language model and reference document information of the large language model.

For example, the memory information in the system memory bank may be stored in an unstructured form, and/or the user portrait attribute information in the user memory bank may be stored in a key-value pair form, and/or the memory information in the conversation memory bank and the memory information actively stored by the user in the user memory bank may be stored in a vector form.

In addition, for example, the information processing module 302, in response to acquiring an operation instruction issued by the user for any memory bank, may complete a corresponding memory bank operation according to the operation instruction, the memory bank operation including addition of new memory information, deletion of existing memory information and modification of the existing memory information.

For example, the information processing module 302 may store the conversation information generated between the user and the large language model in the conversation memory bank in real time, and in response to determining that the stored conversation information meets an extraction condition, extract key information from the stored conversation information, and replace the stored conversation information with the extracted key information.

In addition, for example, the information processing module 302, in response to determining that a memory conversion condition is met and determining that the user portrait attribute information in the user memory bank is required to be updated according to the memory information in the conversation memory bank, may update the user portrait attribute information according to the memory information in the conversation memory bank.

The answer generating module 303 may take the memory information retrieved from the memory bank as the matched memory information, and generate the answer information by the large language model in conjunction with the matched memory information.

For example, the answer generating module 303, in response to acquiring the matched memory information from only one memory bank, may convert the matched memory information into a predetermined format to obtain a first conversion result, generate the answer information using the large language model in conjunction with the first conversion result, and in response to acquiring the matched memory information from at least two different memory banks, fuse the matched memory information acquired from the different memory banks, convert the fusion result into the predetermined format to obtain a second conversion result, and then generate the answer information using the large language model in conjunction with the second conversion result.

For the specific work flow of the embodiment of the apparatus shown in FIG. 3, reference may be made to the related description in the foregoing embodiment of the method, and details are not repeated.

In a word, by adopting the solution of the present disclosure and a memory mechanism, the large language model can span the time and the conversation, and provide more accurate and customized output, a conversation effect is thus improved, and the large language model is closer to reality on the way to AGI.

The solution of the present disclosure may be applied to the field of artificial intelligence, and particularly relates to the fields of natural language processing technologies, large language models, deep learning technologies, or the like. Artificial intelligence is a subject of researching how to cause a computer to simulate certain thought processes and intelligent behaviors (for example, learning, inferring, thinking, planning, or the like) of a human, and includes both hardware-level technologies and software-level technologies. Generally, the hardware technologies of the artificial intelligence include technologies, such as a sensor, a dedicated artificial intelligence chip, cloud computing, distributed storage, big data processing, or the like; the software technologies of the artificial intelligence mainly include a computer vision technology, a voice recognition technology, a natural language processing technology, a machine learning/deep learning technology, a big data processing technology, a knowledge graph technology, or the like.

The memory information, or the like, in the embodiment of the present disclosure is not specific to a specific user, and cannot reflect personal information of a specific user, and in addition, the execution subject of the method according to the present disclosure may obtain the memory information in various public and legal compliance manners. In the technical solution of the present disclosure, the collection, storage, usage, processing, transmission, provision, disclosure, or the like, of involved user personal information are in compliance with relevant laws and regulations, and do not violate public order and good customs.

According to the embodiment of the present disclosure, there are also provided an electronic device, a readable storage medium and a computer program product.

FIG. 4 shows a schematic block diagram of an electronic device 400 which may be configured to implement the embodiment of the present disclosure. The electronic device is intended to represent various forms of digital computers, such as laptop computers, desktop computers, workstations, servers, blade servers, mainframe computers, and other appropriate computers. The electronic device may also represent various forms of mobile apparatuses, such as personal digital assistants, cellular telephones, smart phones, wearable devices, and other similar computing apparatuses. The components shown herein, their connections and relationships, and their functions, are meant to be exemplary only, and are not meant to limit implementation of the present disclosure described and/or claimed herein.

As shown in FIG. 4, the device 400 includes a computing unit 401 which may perform various appropriate actions and processing operations according to a computer program stored in a read only memory (ROM) 402 or a computer program loaded from a storage unit 408 into a random access memory (RAM) 403. Various programs and data necessary for the operation of the device 400 may be also stored in the RAM 403. The computing unit 401, the ROM 402, and the RAM 403 are connected with one other through a bus 404. An input/output (I/O) interface 405 is also connected to the bus 404.

The plural components in the device 400 are connected to the I/O interface 405, and include: an input unit 406, such as a keyboard, a mouse, or the like; an output unit 407, such as various types of displays, speakers, or the like; the storage unit 408, such as a magnetic disk, an optical disk, or the like; and a communication (comm.) unit 409, such as a network card, a modem, a wireless communication transceiver, or the like. The communication unit 409 allows the device 400 to exchange information/data with other devices through a computer network, such as the Internet, and/or various telecommunication networks.

The computing unit 401 may be a variety of general and/or special purpose processing components with processing and computing capabilities. Some examples of the computing unit 401 include, but are not limited to, a central processing unit (CPU), a graphic processing unit (GPU), various dedicated artificial intelligence (AI) computing chips, various computing units running machine learning model algorithms, a digital signal processor (DSP), and any suitable processor, controller, microcontroller, or the like. The computing unit 401 performs the methods and processing operations described above, such as the method according to the present disclosure. For example, in some embodiments, the method according to the present disclosure may be implemented as a computer software program tangibly contained in a machine readable medium, such as the storage unit 408. In some embodiments, part or all of the computer program may be loaded and/or installed into the device 400 via the ROM 402 and/or the communication unit 409. When the computer program is loaded into the RAM 403 and executed by the computing unit 401, one or more steps of the method according to the present disclosure may be performed. Alternatively, in other embodiments, the computing unit 401 may be configured to perform the method according to the present disclosure by any other suitable means (for example, by means of firmware).

Various implementations of the systems and technologies described herein above may be implemented in digital electronic circuitry, integrated circuitry, field programmable gate arrays (FPGA), application specific integrated circuits (ASIC), application specific standard products (ASSP), systems on chips (SOC), complex programmable logic devices (CPLD), computer hardware, firmware, software, and/or combinations thereof. The systems and technologies may be implemented in one or more computer programs which are executable and/or interpretable on a programmable system including at least one programmable processor, and the programmable processor may be special or general, and may receive data and instructions from, and transmit data and instructions to, a storage system, at least one input apparatus, and at least one output apparatus.

Program codes for implementing the method according to the present disclosure may be written in any combination of one or more programming languages. These program codes may be provided to a processor or a controller of a general purpose computer, a special purpose computer, or other programmable data processing apparatuses, such that the program code, when executed by the processor or the controller, causes functions/operations specified in the flowchart and/or the block diagram to be implemented. The program code may be executed entirely on a machine, partly on a machine, partly on a machine as a stand-alone software package and partly on a remote machine, or entirely on a remote machine or a server.

In the context of the present disclosure, the machine readable medium may be a tangible medium which may contain or store a program for use by or in connection with an instruction execution system, apparatus, or device. The machine readable medium may be a machine readable signal medium or a machine readable storage medium. The machine readable medium may include, but is not limited to, an electronic, magnetic, optical, electromagnetic, infrared, or semiconductor system, apparatus, or device, or any suitable combination of the foregoing. More specific examples of the machine readable storage medium may include an electrical connection based on one or more wires, a portable computer disk, a hard disk, a random access memory (RAM), a read only memory (ROM), an erasable programmable read only memory (EPROM or flash memory), an optical fiber, a portable compact disc read only memory (CD-ROM), an optical storage device, a magnetic storage device, or any suitable combination of the foregoing.

To provide interaction with a user, the systems and technologies described here may be implemented on a computer having: a display apparatus (for example, a cathode ray tube (CRT) or liquid crystal display (LCD) monitor) for displaying information to a user; and a keyboard and a pointing apparatus (for example, a mouse or a trackball) by which a user may provide input for the computer. Other kinds of apparatuses may also be used to provide interaction with a user; for example, feedback provided for a user may be any form of sensory feedback (for example, visual feedback, auditory feedback, or tactile feedback); and input from a user may be received in any form (including acoustic, speech or tactile input).

The systems and technologies described here may be implemented in a computing system (for example, as a data server) which includes a back-end component, or a computing system (for example, an application server) which includes a middleware component, or a computing system (for example, a user computer having a graphical user interface or a web browser through which a user may interact with an implementation of the systems and technologies described here) which includes a front-end component, or a computing system which includes any combination of such back-end, middleware, or front-end components. The components of the system may be interconnected through any form or medium of digital data communication (for example, a communication network). Examples of the communication network include: a local area network (LAN), a wide area network (WAN) and the Internet.

A computer system may include a client and a server. Generally, the client and the server are remote from each other and interact through the communication network. The relationship between the client and the server is generated by virtue of computer programs which run on respective computers and have a client-server relationship to each other. The server may be a cloud server or a server of a distributed system, or a server incorporating a blockchain.

It should be understood that various forms of the flows shown above may be used and reordered, and steps may be added or deleted. For example, the steps described in the present disclosure may be executed in parallel, sequentially, or in different orders, which is not limited herein as long as the desired results of the technical solution disclosed in the present disclosure may be achieved.

The above-mentioned implementations are not intended to limit the scope of the present disclosure. It should be understood by those skilled in the art that various modifications, combinations, sub-combinations and substitutions may be made, depending on design requirements and other factors. Any modification, equivalent substitution and improvement made within the spirit and principle of the present disclosure all should be included in the extent of protection of the present disclosure.

What is claimed is:

1. A human-machine interaction method, comprising:
acquiring a question input by a user during a conversation with a large language model;
retrieving memory information in a memory bank, the memory information being historical memory information about the user; and
in response to retrieved memory information required for generating answer information corresponding to the question, taking the retrieved memory information as matched memory information, and generating the answer information by the large language model in conjunction with the matched memory information.

2. The method according to claim 1, wherein the memory bank comprises one or both of a long-term memory bank and a short-term memory bank;
the long-term memory bank comprises a user memory bank; the user memory bank comprises the following memory information: user portrait attribute information of the user; and
the short-term memory bank comprises a conversation memory bank; the conversation memory bank comprises the following memory information: historical conversation information between the user and the large language model within recent predetermined duration.

3. The method according to claim 2, wherein the user portrait attribute information comprises user portrait attribute information generated according to one or both of historical conversation information between the user and the large language model and user information of the user collected from a predetermined data source.

4. The method according to claim 2, wherein the user memory bank also comprises at least one of memory information about identity setting or a personalized requirement of the user stored actively by the user.

5. The method according to claim 2, wherein the long-term memory bank further comprises a system memory bank;
the system memory bank comprises one or any combination of the following memory information: identity setting information of the large language model, background knowledge information of the large language model and reference document information of the large language model.

6. The method according to claim 5, wherein the memory information in the system memory bank is stored in an unstructured form.

7. The method according to claim 3, wherein the user portrait attribute information in the user memory bank is stored in a key-value pair form.

8. The method according to claim 4, wherein the memory information in the conversation memory bank and the memory information actively stored by the user in the user memory bank are stored in a vector form.

9. The method according to claim 5, further comprising:
in response to acquiring an operation instruction issued by the user for any memory bank, completing a corresponding memory bank operation according to the operation instruction, the memory bank operation comprising addition of new memory information, deletion of existing memory information and modification of the existing memory information.

10. The method according to claim 2, further comprising:
storing the conversation information generated between the user and the large language model in the conversation memory bank in real time, and in response to determining that the stored conversation information meets an extraction condition, extracting key information from the stored conversation information, and replacing the stored conversation information with the extracted key information.

11. The method according to claim 3, further comprising:
in response to determining that a memory conversion condition is met and determining that the user portrait attribute information in the user memory bank is required to be updated according to the memory information in the conversation memory bank, updating the user portrait attribute information according to the memory information in the conversation memory bank.

12. The method according to claim 1, wherein generating the answer information by the large language model in conjunction with the matched memory information comprises:
in response to acquiring the matched memory information from only one memory bank, converting the matched memory information into a predetermined format to obtain a first conversion result, and generating the answer information using the large language model in conjunction with the first conversion result; and
in response to acquiring the matched memory information from at least two different memory banks, fusing the matched memory information acquired from the different memory banks, converting the fusion result into a predetermined format to obtain a second conversion result, and generating the answer information using the large language model in conjunction with the second conversion result.

13. An electronic device, comprising:
at least one processor; and
a memory connected with the at least one processor communicatively;
wherein the memory stores instructions executable by the at least one processor to enable the at least one processor to perform a human-machine interaction method, comprising:
acquiring a question input by a user during a conversation with a large language model;
retrieving memory information in a memory bank, the memory information being historical memory information about the user; and
in response to retrieved memory information required for generating answer information corresponding to the question, taking the retrieved memory information as matched memory information, and generating the answer information by the large language model in conjunction with the matched memory information.

14. The electronic device according to claim 13, wherein the memory bank comprises one or both of a long-term memory bank and a short-term memory bank;
the long-term memory bank comprises a user memory bank; the user memory bank comprises the following memory information: user portrait attribute information of the user; and
the short-term memory bank comprises a conversation memory bank; the conversation memory bank comprises the following memory information: historical conversation information between the user and the large language model within recent predetermined duration.

15. The electronic device according to claim 14, wherein the user portrait attribute information comprises user portrait attribute information generated according to one or both of historical conversation information between the user and the large language model and user information of the user collected from a predetermined data source; and
wherein the user memory bank also comprises at least one of memory information about identity setting or a personalized requirement of the user stored actively by the user.

16. The electronic device according to claim 14, wherein the long-term memory bank further comprises a system memory bank;
the system memory bank comprises one or any combination of the following memory information: identity setting information of the large language model, background knowledge information of the large language model and reference document information of the large language model.

17. The electronic device according to claim 14, wherein the method further comprises:
storing the conversation information generated between the user and the large language model in the conversation memory bank in real time, and in response to determining that the stored conversation information meets an extraction condition, extracting key information from the stored conversation information, and replacing the stored conversation information with the extracted key information.

18. The electronic device according to claim 15, wherein the method further comprises:
in response to determining that a memory conversion condition is met and determining that the user portrait attribute information in the user memory bank is required to be updated according to the memory information in the conversation memory bank, updating the user portrait attribute information according to the memory information in the conversation memory bank.

19. The electronic device according to claim 13, wherein generating the answer information by the large language model in conjunction with the matched memory information comprises:
in response to acquiring the matched memory information from only one memory bank, converting the matched memory information into a predetermined format to obtain a first conversion result, and generating the answer information using the large language model in conjunction with the first conversion result; and
in response to acquiring the matched memory information from at least two different memory banks, fusing the matched memory information acquired from the different memory banks, converting the fusion result into a predetermined format to obtain a second conversion result, and generating the answer information using the large language model in conjunction with the second conversion result.

20. A non-transitory computer readable storage medium storing computer instructions for causing a computer to perform a human-machine interaction method, comprising:
acquiring a question input by a user during a conversation with a large language model;
retrieving memory information in a memory bank, the memory information being historical memory information about the user; and
in response to retrieved memory information required for generating answer information corresponding to the question, taking the retrieved memory information as matched memory information, and generating the answer information by the large language model in conjunction with the matched memory information.
